(19) United States
(12) Patent Application Publication
(10) Pub. No.: US 2025/0332852 A1
(43) Pub. Date: Oct. 30, 2025

(54) RECORDING APPARATUS AND CONTROL METHOD THEREOF

(71) Applicant: CANON KABUSHIKI KAISHA, Tokyo (JP)

(72) Inventor: KANTO KURASAWA, Tokyo (JP)

(21) Appl. No.: 19/186,750

(22) Filed: Apr. 23, 2025

(30) Foreign Application Priority Data
Apr. 24, 2024 (JP) 2024-070427

(51) Int. Cl. B41J 15/04; B41J 11/04; B41J 29/393

(52) U.S. Cl. CPC B41J 15/048; B41J 11/04; B41J 29/393; B41J 2203/011

(57) ABSTRACT

A sheet supplied from a roll is conveyed by a first conveyance unit and a second conveyance unit located on a downstream side of the first conveyance unit. The sheet is conveyed by a first conveyance amount while being inspected by a sensor for a spliced portion, which is a splice between sheets, and in a case where the spliced portion is not detected while the sheet is conveyed by the first conveyance amount, the first conveyance amount is changed in a control operation of causing a head to start ejecting liquid onto the sheet.

### BACKGROUND OF THE INVENTION

### Field of the Invention

The present invention relates to a recording apparatus that performs recording on roll paper.

### Description of the Related Art

There are recording apparatuses including a sheet feeding device that feeds a sheet from a roll to a recording head and a winding device that winds up the sheet, on which recording has been performed by the recording head, into a roll. These recording apparatuses may perform splicing using splice tape. The splicing includes a case where a leading end of sheet of a new roll is connected to a trailing end of sheet of the previous roll, a case where, after an unnecessary portion of sheet is removed in a jam clearing operation, the front and rear of the removal section are connected to each other, etc. The spliced portion (splice) is thicker than the other portions and is convex from the surface of the sheet. Therefore, if recording is performed on the spliced portion, the recording head and the spliced portion interfere with each other, and the recording head may be damaged.

In a technique described in Japanese Patent Application Laid-Open No. 2001-239715, an optical sensor is provided on a conveyance path of a sheet to detect a splice between sheets. When a splice is detected, the recording head is capped so as to be in a protective state, and the sheet is conveyed by a fixed amount, thereby avoiding the recording head from being damaged by recording on the splice.

If the sheet is conveyed to avoid recording on the spliced portion, the conveyed portion of the sheet becomes a waste sheet that cannot be used for recording. If a fixed amount of sheet is conveyed each time a splice is detected, the amount of waste sheet increases.

### SUMMARY OF THE INVENTION

The present invention reduces the amount of waste sheet generated in a recording apparatus that conveys a sheet when a splice between sheets is detected.

The present invention is a recording apparatus that records an image by ejecting liquid onto a sheet supplied from a roll around which the sheet is wound, the recording apparatus comprising:
a first conveyance unit configured to convey a sheet in a conveying direction;
a second conveyance unit configured to convey a sheet and provided on a downstream side of the first conveyance unit in the conveying direction;
a head configured to eject liquid onto a sheet at a position between the first conveyance unit and the second conveyance unit in a conveyance path of the sheet;
a sensor configured to detect a spliced portion, which is a splice between sheets, at a detection position on an upstream side of the head in the conveying direction; and
a control unit configured to convey a sheet by a first conveyance amount while inspecting the sheet by the sensor before causing the head to start ejecting liquid, and cause the head to start ejecting the liquid onto the sheet in a case where the spliced portion is not detected by the sensor while the sheet is conveyed by the first conveyance amount,
wherein the control unit changes the first conveyance amount.

Further features of the present invention will become apparent from the following description of exemplary embodiments with reference to the attached drawings.

### BRIEF DESCRIPTION OF THE DRAWINGS

FIG. 1 is a diagram illustrating a configuration of a recording apparatus according to an embodiment;

FIG. 2 is a control block diagram of the recording apparatus according to the embodiment;

FIG. 3 is a diagram illustrating a configuration of the recording apparatus according to the embodiment;

FIG. 4 is a diagram illustrating a configuration of the recording apparatus according to the embodiment;

FIG. 5 is a flowchart illustrating a recording control operation according to the embodiment;

FIG. 6 is a flowchart illustrating recording initial processing according to the embodiment;

FIGS. 7A to 7D are diagrams illustrating a recording operation according to the embodiment;

FIG. 8 is a flowchart illustrating jam occurrence processing according to the embodiment;

FIGS. 9A to 9E are a first diagram illustrating a recording operation performed when a jam has occurred according to the embodiment;

FIG. 10 is a flowchart illustrating a standby process according to the embodiment;

FIGS. 11A to 11E are a second diagram illustrating a recording operation when a jam has occurred according to the embodiment;

FIGS. 12A to 12C are diagrams illustrating a case where conveyance is performed by a user operation when a jam has occurred according to the embodiment;

FIGS. 13A to 13C are diagrams illustrating a recording operation according to Comparative Example 1;

FIG. 14 is a flowchart illustrating recording initial processing according to Comparative Example 1;

FIGS. 15A to 15D are diagrams illustrating a recording operation performed when a jam has occurred according to Comparative Example 1;

FIGS. 16A to 16E are diagrams illustrating a recording operation performed a jam has occurred according to Comparative Example 2; and

FIG. 17 is a diagram illustrating another configuration of the recording apparatus according to the embodiment.

### DESCRIPTION OF THE EMBODIMENTS

Hereinafter, exemplary embodiments for implementing the present invention will be described with reference to the drawings. However, the dimensions, materials, shapes, relative arrangements, etc. of components described in the following embodiments can be appropriately changed in accordance with the configuration and various conditions of an apparatus to which the present invention is applied, and the scope of the present invention is not intended to be limited to the following embodiments.

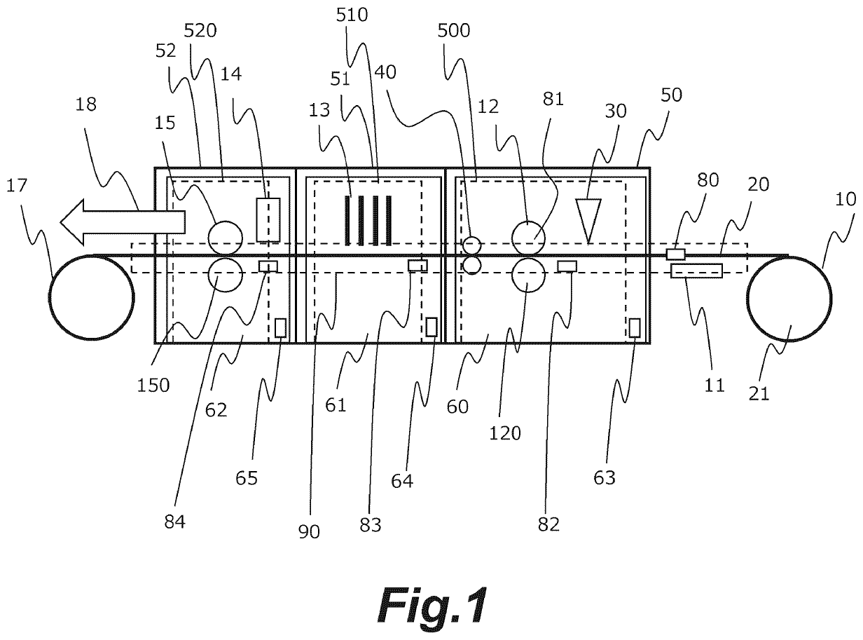

FIG. 1 is a diagram conceptually illustrating a configuration of a recording apparatus 1 (printing apparatus) according to an embodiment. The recording apparatus 1 records an image by ejecting liquid onto a sheet 20 supplied from a roll 21. The recording apparatus 1 includes a sheet feeding device 10, a main conveyance unit 12, a sub conveyance unit 15, and a winding device 17, and also includes a dancer roller (not illustrated) for controlling tension of the sheet 20 between the sheet feeding device 10 and the winding device 17. The main conveyance unit 12 is a first conveyance unit that nips the sheet 20 by a nip portion of a roller pair 120 and conveys the sheet 20 in a conveying direction 18, and the sub conveyance unit 15 is a second conveyance unit that nips the sheet 20 by a nip portion of a roller pair 150 and conveys the sheet 20 in the conveying direction 18. The sub conveyance unit 15 is provided on the downstream side of the main conveyance unit 12 in the conveying direction 18 of the sheet 20. The sheet feeding device 10, which is a sheet feeding unit that feeds the sheet 20 from the roll 21, is provided on the upstream side of the main conveyance unit 12 in the conveying direction 18. The winding device 17, which is a winding unit that winds the sheet 20, is provided on the downstream side of the sub conveyance unit 15 in the conveying direction 18.

A conveyance path 90 of the sheet 20 is conceptually illustrated as a straight line in FIG. 1. However, the conveyance path 90 of the actual apparatus does not need to be formed straight. For example, the conveyance path 90 may include a path extending in a direction away from the sheet feeding device 10, and recording is performed in this path. In addition, the conveyance path 90 may include another path provided below the above-described path, and the sheet 20 on which the recording has been performed is dried and cooled in this path. Further, the conveyance path 90 may include yet another path provided below the above-described path, and the sheet 20 that has been dried and cooled is conveyed toward the winding device 17 through this path, and these paths may collectively form an S-shape as a whole.

The main conveyance unit 12 includes an encoder 81 capable of measuring the amount of rotation of the roller pair 120. The encoder 81 is provided at a position on a drive shaft between the roller pair 120 and a motor (not illustrated) for driving the roller pair 120. The conveyance amount of the sheet 20 can be obtained from a value acquired from the encoder 81.

The roll 21 is attached to the sheet feeding device 10. A splicing board 11 and a splice detector 30 are provided at a position on the downstream side of the sheet feeding device 10 in the conveying direction 18. When a user replaces the roll 21, the sheet 20 is cut on the splicing board 11, and the roll 21 of the sheet feeding device 10 is replaced. Next, the trailing end of the cut sheet 20 remaining in the recording apparatus 1 and the leading end of a new roll 21 are connected (spliced) to each other with splicing tape. The portion connected with the splicing tape is referred to as a spliced portion 80. The roll 21 can be replaced by pulling out a sheet 20 from the new roll 21 set in the sheet feeding device 10 up to the position of the splicing board 11 and performing splicing.

The splice detector 30 is a sensor capable of detecting the spliced portion 80, which is a splice between the sheets 20, at a detection position on the upstream side of a head 13 in the conveying direction 18. A meandering correction device 40 that corrects and stabilizes the position of the sheet 20 in the width direction (a direction perpendicular to the conveying direction 18 and parallel to the recording surface of the sheet 20, a paper depth direction in FIG. 1) during conveyance is disposed on the downstream side of the main conveyance unit 12 in the conveying direction 18, and performs meandering correction on the sheet 20. The head 13, which is a recording unit including each color, is disposed on the downstream side of the meandering correction device 40 in the conveying direction 18. The head 13 ejects liquid (ink) onto the sheet 20 at a position between the main conveyance unit 12 and the sub conveyance unit 15 in the conveyance path 90 of the sheet 20. The head 13 ejects ink onto the sheet 20 conveyed in the conveying direction 18, thereby performing recording. When the recording has been performed, the ink ejected onto the sheet 20 is dried and cooled by a fixing unit 14. The fixing unit 14 includes a dryer including a heater and a fan, and performs drying by the dryer. The fixing unit 14 further includes a cooler including a fan, and after the drying has been performed by the dryer, the sheet 20 heated by the drying and the ink ejected onto the sheet 20 are cooled by the cooler. After the cooling, the sheet 20 passes through the sub conveyance unit 15. The end of the sheet 20 is connected to the winding device 17, and the conveyed sheet 20 is wound around the winding device 17.

The recording apparatus 1 includes a housing that contains at least a part of the conveyance path 90 of the sheet 20 inside. In the embodiment, the recording apparatus 1 includes a plurality of housings (a first housing 50, a second housing 51, and a third housing 52) along the conveying direction 18. The first housing 50 contains the splice detector 30, the main conveyance unit 12, and the meandering correction device 40 in the conveyance path 90 inside. The second housing 51 contains the head 13 in the conveyance path 90 inside. The third housing 52 contains the fixing unit 14 and the sub conveyance unit 15 in the conveyance path 90 inside.

The first housing 50 includes an opening 500, a first door 60 that can open and close the opening 500, and a first opening/closing sensor 63 that can detect opening and closing of the first door 60. A user operation can be performed on the sheet 20 on the conveyance path 90 in the first housing 50 via the opening 500. The second housing 51 includes an opening 510, a second door 61 that can open and close the opening 510, and a second opening/closing sensor 64 that can detect opening and closing of the second door 61. The user operation can be performed on the sheet 20 on the conveyance path 90 in the second housing 51 via the opening 510. The third housing 52 includes an opening 520, a third door 62 that can open and close the opening 520, and a third opening/closing sensor 65 that can detect opening and closing of the third door 62. The user operation can be performed on the sheet 20 on the conveyance path 90 in the third housing 52 via the opening 520.

A position that is operable in the sheet 20 via each of the plurality of openings 500, 510, and 520 is different from one another. When the doors of the respective housings are closed, the user cannot operate (access) the sheet 20 on the conveyance path 90 in the housings. The recording apparatus 1 is controlled to perform a recording operation only when the first opening/closing sensor 63, the second opening/closing sensor 64, and the third opening/closing sensor 65 detect the opening/closing states of the respective doors and determine that all the doors are closed. This prevents the user from accidentally touching the sheet 20 being conveyed during the recording operation. Further, when the user needs to touch the sheet 20 to perform the operation, such as a jam clearing operation, the sheet 20 is controlled to be in a stopped state. That is, the main conveyance unit 12 and the sub conveyance unit 15 are stopped. In this state, the user can open the door of each housing and perform work such as a jam clearing operation. A door lock mechanism may be provided to restrict opening and closing of the door by the user operation.

When the user performs a jam clearing operation on the sheet 20 in the recording apparatus 1, the user opens the door of the housing containing the conveyance path 90 that includes a position where the sheet 20 is jammed in the conveyance path 90, and removes a jammed portion of the sheet 20. Next, the user connects the intact portions of the sheet 20 with each other by splicing, and closes the door. Thus, the jam clearing operation is complete. The first housing 50, the second housing 51, and the third housing 52 include a first jam detector 82, a second jam detector 83, and a third jam detector 84, respectively, and when a jam occurs in the sheet 20 on the conveyance path 90 in any of the housings, the corresponding jam detector can detect the jam.

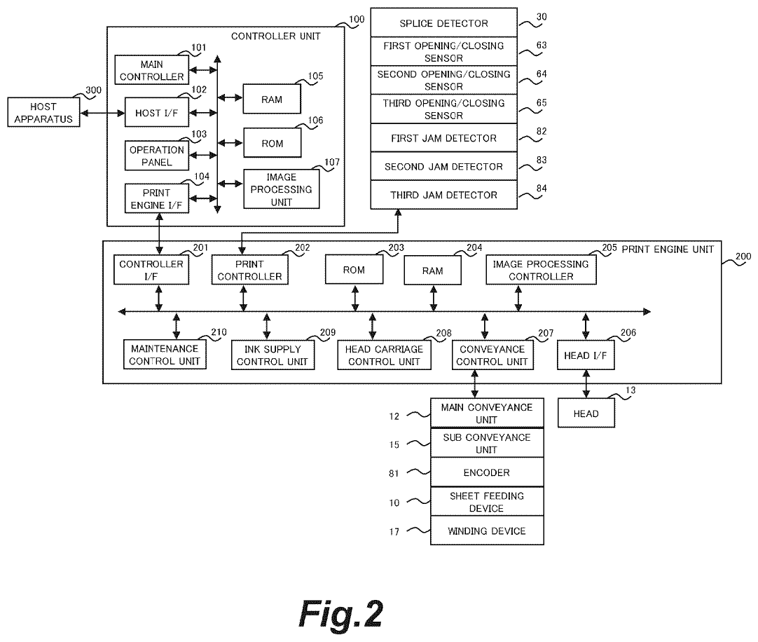

FIG. 2 is a block diagram illustrating a control configuration of the recording apparatus 1. The recording apparatus 1 includes a print engine unit 200 that mainly controls a recording operation and a controller unit 100 that controls the overall operation of the recording apparatus 1. A print controller 202 of the print engine unit 200 controls the operation of each component of the print engine unit 200 in accordance with an instruction from a main controller 101 of the controller unit 100.

In the controller unit 100, a main controller 101 constituted by a CPU controls the entire recording apparatus 1 in accordance with programs and various parameters stored in a ROM 106 while using a RAM 105 as a work area. For example, when a recording instruction is entered from a host apparatus 300 via a host I/F 102, an image processing unit 107 performs predetermined image processing on received image date in accordance with an instruction from the main controller 101. The main controller 101 transmits the processed image data to the print engine unit 200 via a print engine I/F 104.

The recording apparatus 1 may include a storage device I/F to which an external storage device (a USB memory or the like) is connectable, and may acquire image data from the connected external storage device. An operation panel 103 includes an operation unit through which the user enters instructions for the recording apparatus 1 and a display unit for notifying the user of the state of the recording apparatus 1. Via the operation panel 103, the user can instruct the recording apparatus 1 to perform operations for starting recording and paper feeding, set a recording mode (print mode), and recognize information about the recording apparatus 1. For example, the operation panel 103 may have a configuration including a touch panel and buttons. Alternatively, an external input device such as a mouse or a keyboard may be connected to the recording apparatus 1 to receive instruction inputs.

In the print engine unit 200, the print controller 202 constituted by a CPU controls the operation of each unit included in the recording apparatus 1 in accordance with programs and various parameters stored in a ROM 203 while using a RAM 204 as a work area. When various commands and image data are received via a controller I/F 201, the print controller 202 temporarily stores these commands and image data in the RAM 204. The print controller 202 causes an image processing controller 205 to convert the stored image data into recording data so that the head 13 can use the recording data for a recording operation. When the recording data is generated, the print controller 202 causes the head 13 to execute the recording operation based on the recording data via a head I/F 206. Further, the print controller 202 causes a conveyance control unit 207 to drive the sheet feeding device 10, the main conveyance unit 12, the sub conveyance unit 15, and the winding device 17 to convey the sheet 20. In addition, the conveyance control unit 207 can detect the conveyance amount of the sheet 20 by using the encoder 81 provided in the roller pair 120 of the main conveyance unit 12. The print controller 202 executes a control operation (a recording control operation) for causing the recording apparatus 1 to perform a recording operation when receiving an instruction (a recording instruction, a print instruction) to perform recording on the sheet 20 from the controller unit 100.

The head 13 is disposed above the sheet 20 and is configured to be movable in the vertical direction so as to move downward to be closer to the sheet 20 when recording is performed and move upward to be away from the sheet 20 during a maintenance mode or the like. A head carriage control unit 208 changes the vertical position of the head 13 in accordance with the operational state of the recording apparatus 1, such as the maintenance mode or a recording mode. An ink supply control unit 209 controls an ink supply unit such that the pressure of the ink supplied to the head 13 falls within an appropriate range. When performing a maintenance operation on the head 13, a maintenance control unit 210 moves a maintenance unit to a position below the raised head, and controls the maintenance operation performed on the head 13, such as capping or wiping.

### Setting Pre-Ejection Conveyance Amount

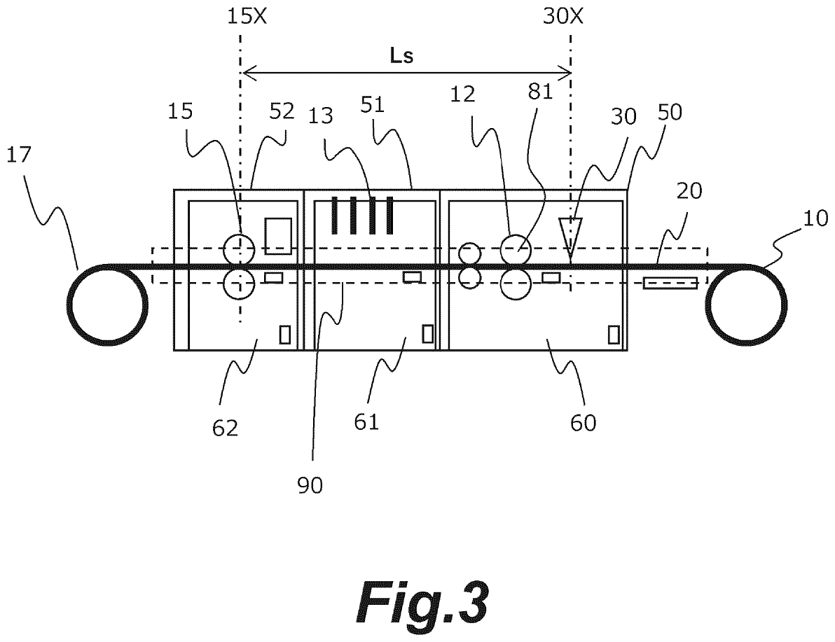

The impact on the recording apparatus 1 when the spliced portion 80 passes through the conveyance path 90 during recording will be described with reference to FIG. 3. Since the spliced portion 80 is convex with respect to the sheet 20, when the spliced portion passes through the nip portions of the roller pair 120 of the main conveyance unit 12 and the roller pair 150 of the sub conveyance unit 15, the conveyance accuracy could decrease. Further, when the spliced portion 80 passes below the head 13 in the state where the head 13 is lowered to be closer to the sheet 20 for recording, the convex portion of the spliced portion 80 could come into contact with the ejection surface of the head 13 and damage the head 13.

In order to prevent a decrease in the conveyance accuracy and damage to the head 13, in the embodiment, the print controller 202 performs the following recording control operation when receiving a recording instruction to perform recording on the sheet 20. The recording instruction is entered to the controller unit 100 through communication with the host apparatus 300 or a user operation on the operation panel 103 (for example, an operation of a button or a touch panel).

The print controller 202 performs a setting step for setting the amount (length) of the sheet 20 to be conveyed before the start of ejection as a pre-ejection conveyance amount Z (first conveyance amount). The set pre-ejection conveyance amount Z is stored in, for example, the RAM 204, and can be referred to in subsequent processing.

Next, the print controller 202 performs a conveyance step of conveying the sheet 20 by the pre-ejection conveyance amount Z while inspecting the sheet 20 by the splice detector 30. In a case where no spliced portion 80 is detected by the splice detector 30 in the conveyance step, the print controller 202 causes the head 13 to start ejecting the liquid (ink) onto the sheet 20.

A distance along the conveyance path 90 between a detection position 30X at which a spliced portion 80 is detected by the splice detector 30 and a position 15X of the sub conveyance unit 15 is defined as a detection distance Ls. In an initial recording operation performed after the recording apparatus 1 is activated, the print controller 202 sets the pre-ejection conveyance amount Z based on the detection distance Ls. In the embodiment, Z=Ls. Thus, the ejection can be started in a state where there is no spliced portion 80 on the sheet 20 in the range from the splice detector 30 to the sub conveyance unit 15 in the conveyance path 90.

In a second and subsequent recording operations after the initial recording instruction, the print controller 202 sets the pre-ejection conveyance amount Z to 0 (zero). This can prevent the occurrence of waste sheet in the second and subsequent recording operations. In the second and subsequent recording operations, it has been checked at the end of the previous recording operation that the sheet 20 has no spliced portion 80 in the range from the splice detector 30 to the sub conveyance unit 15 in the conveyance path 90. Therefore, even if the ejection is started without performing the pre-ejection conveyance, a decrease in the conveyance accuracy and damage to the head 13 caused by the spliced portion 80 do not occur.

### Setting Pre-Ejection Conveyance Amount in Jam Clearing Operation

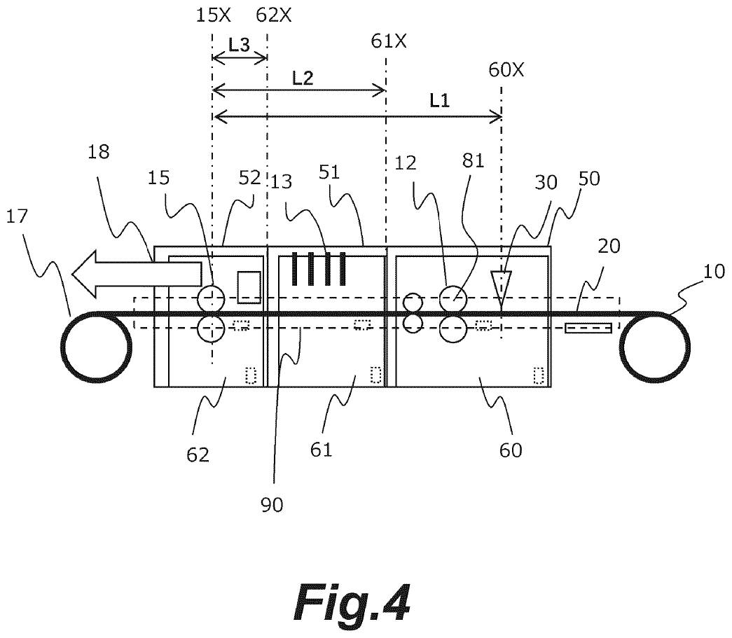

According to the embodiment, the pre-ejection conveyance amount Z is appropriately set in accordance with the door (the housing in which the jammed portion is present) opened by the user in the jam clearing operation. Hereinafter, a method for setting the pre-ejection conveyance amount Z for resuming recording after the jam clearing operation according to the embodiment will be described with reference to FIG. 4. FIG. 4 is a diagram illustrating door distances for determining the pre-ejection conveyance amounts corresponding to the respective doors.

When the door of each housing is opened, the user can perform an operation such as splicing on the sheet 20 on the conveyance path 90 in the housing. A distance along the conveyance path 90 between and a position of the sub conveyance unit 15 and a most upstream position (hereinafter, referred to as an operable upstream end position) of the sheet 20 in the housing in the conveying direction 18, the sheet 20 being operable by the user while the door is opened, is defined as a door distance. The door distance is a distance from the nip portion of the sub conveyance unit 15, which serves as a reference point, to a most upstream position of the sheet 20 on the conveyance path 90 in the housing, the position being accessible by the user while the door is opened.

As illustrated in FIG. 4, a door distance corresponding to the first door 60 is represented by a distance L1 along the conveyance path 90 between the position 15X (the position of the nip portion) of the sub conveyance unit 15 and an operable upstream end position 60X of the first door 60. A door distance corresponding to the second door 61 is represented by a distance L2 along the conveyance path 90 between the position 15X of the sub conveyance unit 15 and an operable upstream end position 61X of the second door 61. A door distance corresponding to the third door 62 is represented by a distance L3 along the conveyance path 90 between the position 15X of the sub conveyance unit 15 and an operable upstream end position 62X of the third door 62. In the embodiment, the door distance L1 corresponding to the first door 60 is assumed to be equal to the detection distance Ls. That is, the operable upstream end position 60X of the first door 60 is assumed to be the same as the detection position 30X at which the splice detector 30 detects the spliced portion. Alternatively, the operable upstream end position 60X of the first door 60 and the detection position 30X may be different.

In the embodiment, in the recording operation performed in response to a recording instruction after the opening/closing sensor has detected the opening and closing of any one of the plurality of doors, the pre-ejection conveyance amount Z is set based on a door distance Ln (in the embodiment, n=1, 2, 3) corresponding to the opened and closed door. That is, when the first door 60 is opened and closed, the pre-ejection conveyance amount Z=L1 is set, when the second door 61 is opened and closed, the pre-ejection conveyance amount Z=L2 is set, and when the third door 62 is opened and closed, the pre-ejection conveyance amount Z=L3 is set.

When the door is opened and closed in the jam clearing operation, it is assumed that the user performs splicing on the sheet 20 at a position somewhere in the conveyance path 90 in the housing that is accessible by the user. By setting the pre-ejection conveyance amount Z as in the embodiment, the sheet 20 is conveyed until the spliced portion 80 passes through the nip portion of the sub conveyance unit 15 in the recording operation after the jam clearing operation. Further, when the door is opened and closed while the recording apparatus 1 is in a standby state, there is a possibility, other than the jam clearing operation, that some unintended abnormality occurs in the sheet 20 on the conveyance path 90 in the housing, which is accessible by the user. In this case, too, the sheet 20 is conveyed until the abnormal portion passes through the nip portion of the sub conveyance unit 15 in the recording operation after the door is closed. Next, when the splice detector 30 has detected no spliced portion 80 in the conveyance step, the ejection is started. Therefore, even when the spliced portion 80 is generated by the jam clearing operation by the user, the ejection is started in a state where no spliced portion 80 is present in the sheet 20 in the range from the splice detector 30 to the sub conveyance unit 15 in the conveyance path 90. Thus, a decrease in the conveyance accuracy and damage to the head 13 can be prevented. Further, since the minimum pre-ejection conveyance amount needed for conveying the spliced portion 80 to the downstream side of the sub conveyance unit 15 is set in accordance with the opened and closed door, the amount of waste sheet caused by the pre-ejection conveyance can be reduced.

Alternatively, the pre-ejection conveyance amount Z may be set based on the door distance, only in a case where the opening and closing of the door is detected after abnormality of the sheet 20 is detected by an abnormality detection unit for detecting abnormality of the sheet 20 in the conveyance path 90. The abnormality of the sheet 20 is, for example, occurrence of a jam, and in this case, the first jam detector 82, the second jam detector 83, and the third jam detector 84 serve as the abnormality detection unit.

Hereinafter, a recording control operation according to the embodiment will be described in detail. This recording control operation can prevent a decrease in the conveyance accuracy and damage to the head 13 while reducing occurrence of waste sheet.

### Initial Recording Operation

When the user performs an operation of instructing a recording operation (printing) on the operation panel 103, the print engine unit 200 starts a recording control operation. Note that the operation of instructing the recording operation is not limited to be performed as the input by the user operation on the operation panel 103, and may be performed as an input to the controller unit 100 through communication from the host apparatus 300. The same applies to the input of the instruction for the recording operation to the controller unit 100 in the following description.

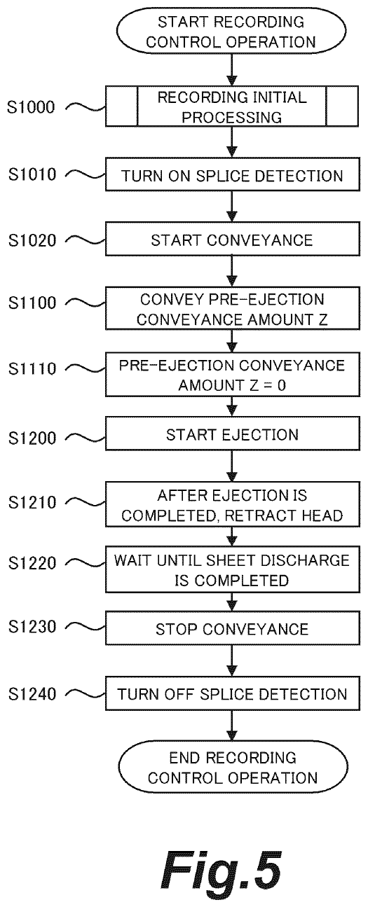

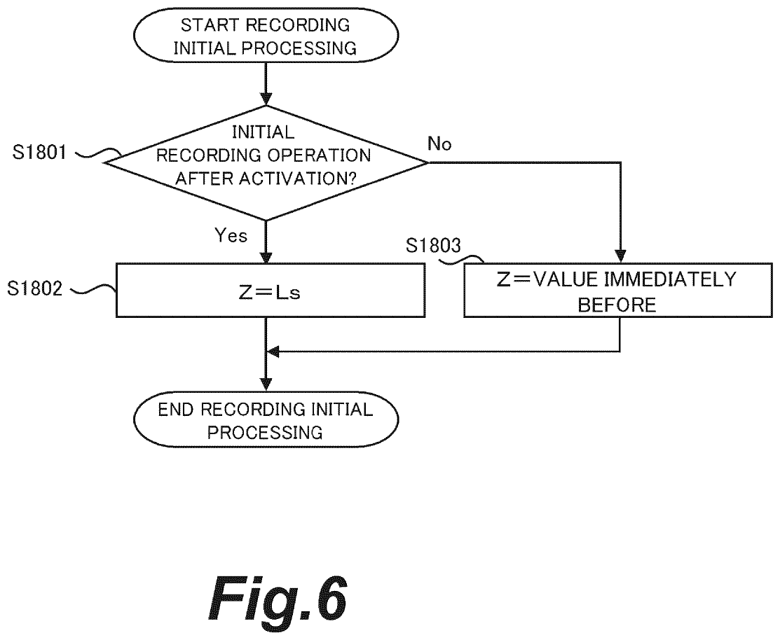

Hereinafter, an initial recording operation after the recording apparatus 1 is activated will be described. FIG. 5 is a flowchart illustrating the recording operation. In step S1000 in FIG. 5, the print controller 202 executes recording initial processing. FIG. 6 is a flowchart illustrating the recording initial processing according to the embodiment. In the recording initial processing in FIG. 6, in step S1801, the print controller 202 determines whether the current recording operation is an initial recording operation after the activation of the recording apparatus 1. If the current recording operation is the initial recording operation (Yes in step S1801), the print controller 202 performs the processing in step S1802. If the current recording operation is a second or subsequent recording operation after the initial recording operation (No in step S1801), the print controller 202 performs the processing in step S1803. Since the recording operation here is the initial recording operation, the processing in step S1802 is performed.

In step S1802, the print controller 202 sets a default value, which is set when the recording apparatus 1 is activated, as a pre-ejection conveyance amount Z. In the embodiment, the pre-ejection conveyance amount Z is set to Ls, which is the default value set when the recording apparatus 1 is activated. Step S1803 performed in the second and subsequent recording operations will be described below.

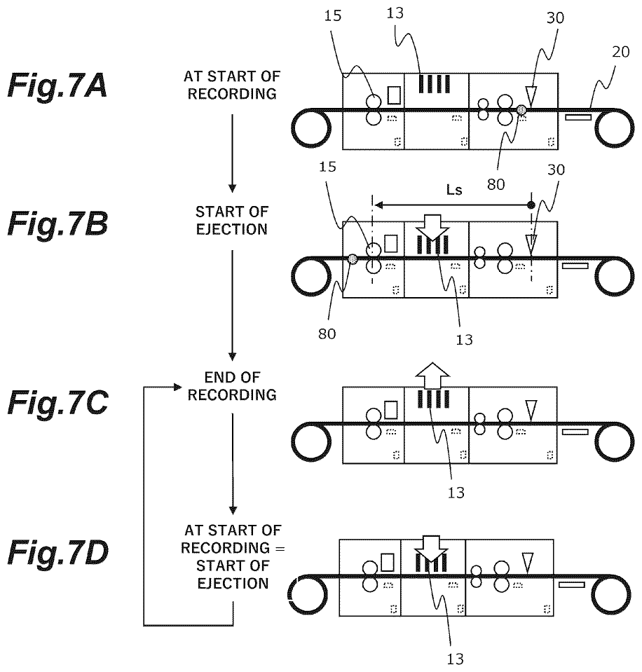

FIGS. 7A to 7D are diagrams illustrating states of the recording apparatus 1 in the initial recording operation and the second and subsequent recording operations. FIG. 7A illustrates the state of the recording apparatus 1 when the recording initial processing in step S1000 is completed. The head 13 has been moved upward, away from the sheet 20.

Next, in step S1010, the print controller 202 turns on the splice detection of the splice detector 30. When the spliced portion 80 passes under the splice detector 30 during the execution of the following processing, the splice detector 30 detects the spliced portion 80, which is indicated as an error, and the recording operation is terminated. When no spliced portion 80 is detected, the following process is executed. Note that the splice detector 30 may be configured to detect not only the spliced portion 80 but also any sort of abnormality on the surface of the sheet 20.

In step S1020, the conveyance control unit 207 starts a driving control operation of the sheet feeding device 10, the main conveyance unit 12, the sub conveyance unit 15, and the winding device 17 to start conveyance of the sheet 20.

In step S1100, the print controller 202 waits until the pre-ejection conveyance amount Z of the sheet 20 has been conveyed.

In step S1110, the print controller 202 sets the pre-ejection conveyance amount Z to 0.

In step S1200, the head carriage control unit 208 lowers the head 13, and the print controller 202 causes the head 13 to start ejection via the head I/F 206.

In step S1210, when the ejection by the head 13 is completed (the recording of the image based on the image data is completed), the head carriage control unit 208 raises the head 13.

In step S1220, the conveyance control unit 207 waits until all the area of the sheet 20 where the image has been recorded reaches a sheet discharge position.

In step S1230, the conveyance control unit 207 ends the driving control operation of the sheet feeding device 10, the main conveyance unit 12, the sub conveyance unit 15, and the winding device 17, and stops the conveyance of the sheet 20.

In step S1240, the print controller 202 turns off the splice detection of the splice detector 30, and thus, the recording operation ends.

In accordance with the sequence described above, the initial recording operation after the activation of the recording apparatus 1 is performed. FIG. 7B illustrates the state in which the processing from step S1010 to step S1200 has been performed in the initial recording operation. Thereafter, the processing from step S1210 to step S1240 is performed, and the recording operation ends. FIG. 7C illustrates the state of the recording apparatus 1 at this point.

The sheet 20 of the pre-ejection conveyance amount Z=Ls is conveyed in steps S1020 to S1100. Therefore, it has been checked by the splice detector 30 that the sheet 20 has no spliced portion 80 in the range from the splice detector 30 to the sub conveyance unit 15 in the conveyance path 90. Therefore, the spliced portion 80 does not pass through the sub conveyance unit 15 or below the head 13 in the recording operation so that a decrease in the conveyance accuracy and damage to the head in the recording operation can be prevented. However, the sheet 20 with a length of Ls will be a waste sheet, which is not used for recording.

### Second and Subsequent Recording Operations

When the initial recording operation is completed, the recording apparatus 1 enters a standby state. During the standby state, when the user operates the operation panel 103 to instruct the second recording operation, the recording control operation in FIG. 5 is started. In the second recording operation, step S1803 in the recording initial processing in FIG. 6, which is performed in step S1000, is performed.

In step S1803, the print controller 202 sets the pre-ejection conveyance amount set in the immediately preceding processing as the pre-ejection conveyance amount Z. In other words, the pre-ejection conveyance amount most recently stored in the RAM 204 in the previous recording operation is read out, and the recording operation is performed based on the obtained pre-ejection conveyance amount. In the embodiment, since the pre-ejection conveyance amount Z is set to 0 in step S1110 in the initial recording operation, the pre-ejection conveyance amount set in the processing immediately before the second recording operation is 0 (zero).

Next, the processing in step S1010 and step S1020 is performed to start conveyance. In the next step S1100, since the pre-ejection conveyance amount Z=0, the process immediately proceeds to step S1200 via step S1110, and ejection is started. Next, the processing from step S1200 to step S1240 is performed, and the recording operation ends.

FIG. 7D illustrates the state of the recording apparatus 1 at this point. In the second recording operation, since the pre-ejection conveyance amount in step S1100 is zero, no waste sheet is generated.

### Jam Occurrence Processing (in First Housing)

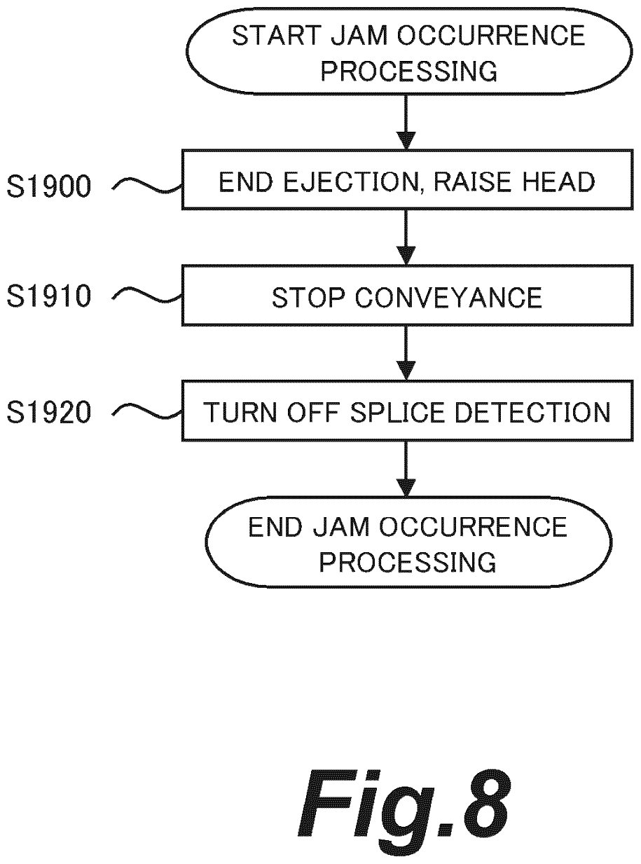

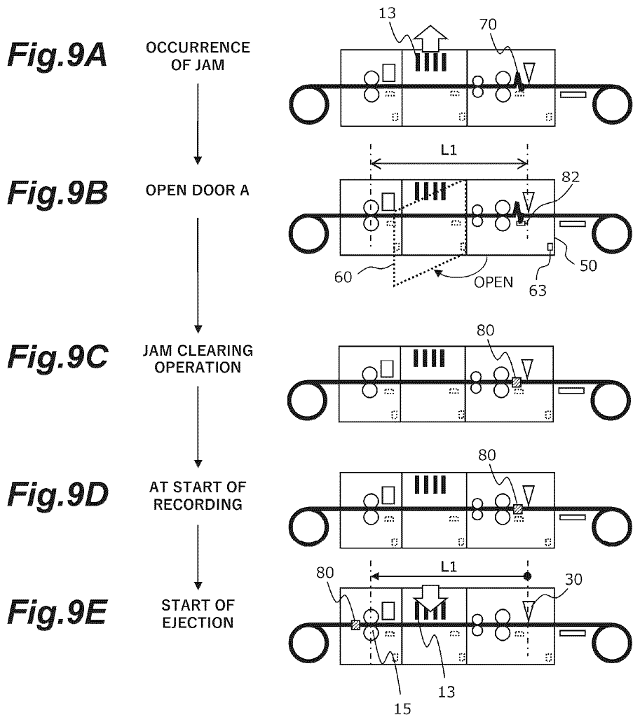

A sequence in which a jam occurs between step S1200 and step S1210 in the initial recording operation, and the second recording operation is performed (the recording operation is resumed) after a jam clearing operation is performed will be described. FIG. 8 is a flowchart illustrating jam occurrence processing. When a jam is detected by any one of the first jam detector 82, the second jam detector 83, and the third jam detector 84, the print controller 202 starts the jam occurrence processing illustrated in FIG. 8. Here, a case where the first jam detector 82 has detected a jam will be described as an example with reference to FIGS. 9A to 9E. FIGS. 9A to 9E are diagrams illustrating states of the recording apparatus 1 in a case where a jammed portion 70 has occurred between the splice detector 30 and the main conveyance unit 12 in the conveyance path 90 in the first housing 50.

In step S1900, the print controller 202 terminates the ejection by the head 13, and the head carriage control unit 208 raises the head 13. FIG. 9A illustrates the state of the recording apparatus 1 at this point.

In step S1910, the conveyance control unit 207 stops driving the sheet feeding device 10, the main conveyance unit 12, the sub conveyance unit 15, and the winding device 17 to stop the conveyance of the sheet 20.

In step S1920, the print controller 202 turns off the splice detection of the splice detector 30.

When the jam occurrence processing is completed, the recording apparatus 1 enters a standby state. The user performs the jam clearing operation while the recording apparatus 1 is in the standby state. In the example in FIGS. 9A to 9E, the user can perform the jam clearing operation by opening the first door 60 of the first housing 50, cutting out the jammed portion 70 to perform splicing, and closing the first door 60.

### Standby Process After Occurrence of Jam

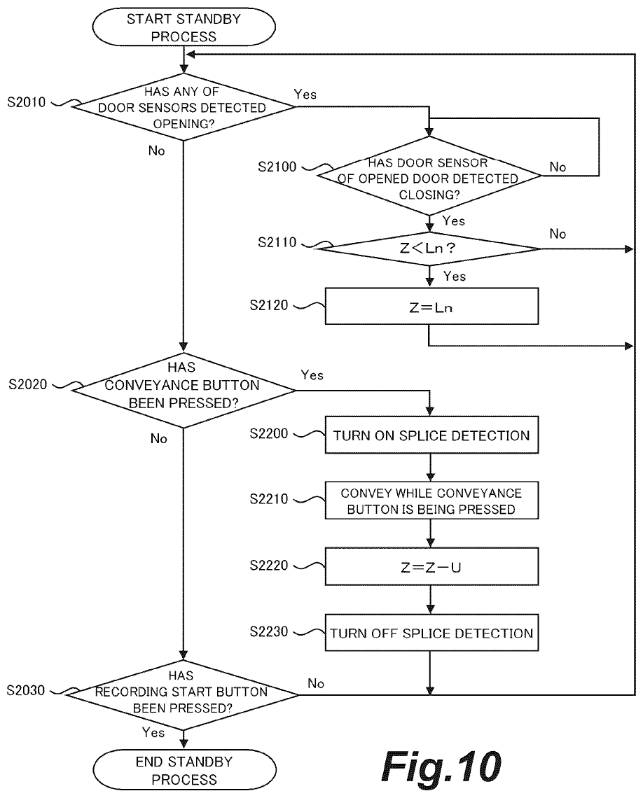

After the jam occurrence processing in FIG. 8 is completed, the recording apparatus 1 enters a standby state. At this point, the print controller 202 executes a standby process illustrated in FIG. 10. Hereinafter, the flow of the standby process will be described. FIG. 10 is a flowchart illustrating the standby process for setting a pre-ejection conveyance amount to be used in the next recording operation in accordance with the door opened for the jam clearing operation.

In step S2010, the print controller 202 determines whether any of the first opening/closing sensor 63, the second opening/closing sensor 64, and the third opening/closing sensor 65 has detected opening of the door (detection of opening). If it is determined that any of the opening/closing sensors has detected opening (Yes in step S2010), the process proceeds to step S2100. If none of the opening/closing sensors have detected opening (No in step S2010), the process proceeds to step S2020. In this example, it is assumed that the user has opened the first door 60 and the first opening/closing sensor 63 has detected the opening of the first door 60. FIG. 9B illustrates the state of the recording apparatus 1 at this point. In this state, the user performs the jam clearing operation on the sheet 20 in the first housing 50, performs splicing, and closes the first door 60. FIG. 9C illustrates the state of the recording apparatus 1 at this point.

In step S2100, the print controller 202 determines whether the opening/closing sensor has detected that the door detected to be opening in step S2010 has been closed (detection of closing). If the closing is detected (Yes in step S2100), the print controller 202 proceeds to step S2110. If the closing is not detected (No in step S2100), the print controller 202 performs step S2100 again.

In step S2110, the print controller 202 compares the pre-ejection conveyance amount Z with the door distance Ln (n=1, 2, 3) corresponding to the door detected to be opening in step S2010. The pre-ejection conveyance amount Z to be compared here is the pre-ejection conveyance amount Z that is set in the immediately preceding processing and stored in the RAM 204. Since the first opening/closing sensor 63 has detected the opening of the first door 60, the door distance Ln=L1. Thus, in this case, it is determined whether Z<L1 holds. If Z<L1 holds, the process proceeds to step S2120. If Z<L1 does not hold, the process returns to step S2010. In this case, the jam has occurred after the pre-ejection conveyance amount Z had been set to 0 in step S1110 in FIG. 5. Therefore, Z=0, and Z<L1 holds. Thus, the process proceeds to step S2120.

In step S2120, the pre-ejection conveyance amount Z is set based on the door distance Ln corresponding to the door detected to be opening in step S2010. In the embodiment, the pre-ejection conveyance amount Z is set to the door distance Ln. Here, since the door detected to be opening is the first door 60, the pre-ejection conveyance amount Z is updated to L1. Thereafter, the process returns to step S2010.

In step S2020, the print controller 202 determines whether the user has performed an operation (hereinafter, referred to as a conveyance operation) of conveying the sheet 20 by any given conveyance amount through the operation panel 103. For example, the operation panel 103 includes a conveyance button as an input unit, and by pressing the conveyance button, the user can enter a conveyance instruction to convey the sheet 20 by a given conveyance amount. If it is determined that the user has performed the conveyance operation through the operation panel 103, the print controller 202 proceeds to step S2200. If it is determined that the user has not performed the conveyance operation through the operation panel 103, the process proceeds to step S2030. The processing from step S2200 onward will be described below.

In step S2030, the print controller 202 determines whether the user has performed an operation of instructing the start of a recording operation (hereinafter, referred to as a recording start operation) through the operation panel 103. For example, the operation panel 103 includes a recording start button, and by pressing the recording start button, the user can cause the recording apparatus 1 to start the recording operation. If it is determined that the user has not performed the recording start operation through the operation panel 103, the print controller 202 returns to step S2010. If it is determined that the user has performed the recording start operation through the operation panel 103, the print controller 202 ends the standby process and starts the recording control operation in FIG. 5.

The recording operation performed after the jam clearing operation performed on the jam that has occurred in the initial recording operation can be referred to as the second recording operation. This recording operation is started in the state illustrated in FIG. 9D in accordance with the recording control operation illustrated in FIG. 5.

In step S1100, when the sheet 20 has been conveyed by the pre-ejection conveyance amount Z=L1 set in step S2120, the process proceeds to step S1110. FIG. 9E illustrates the state of the recording apparatus 1 at this point. The spliced portion 80 is located on the downstream side of the sub conveyance unit 15 in the conveying direction. Therefore, a decrease in the conveyance accuracy and damage to the head 13 in the recording operation can be prevented. In addition, a waste sheet of L1 is generated.

### Jam Occurrence Processing (in Second Housing)

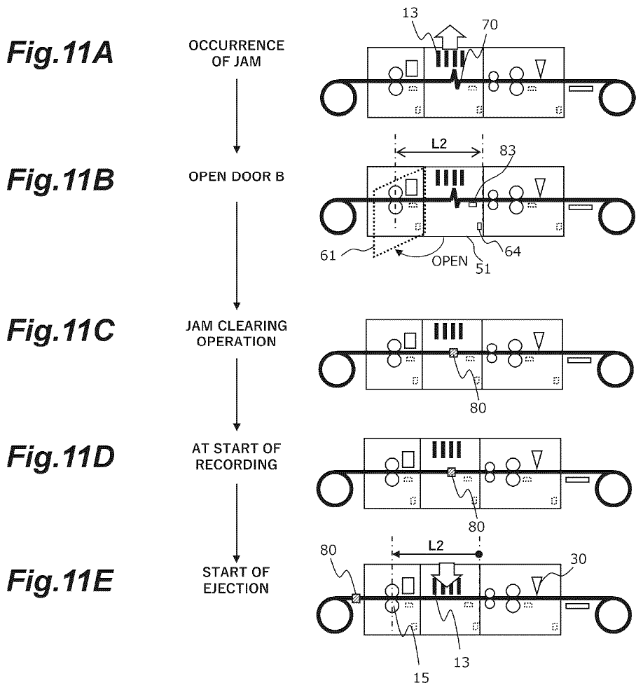

As another example, a process in a case where a jam has occurred in the second housing 51 in the initial recording operation will be described. FIGS. 11A to 11E are diagrams illustrating a state of the recording apparatus 1 when a jammed portion 70 has occurred in the conveyance path 90 in the second housing 51. FIG. 11A illustrates the state of the recording apparatus 1 in this case. When the recording control operation illustrated in FIG. 5 is executed and a jam occurs between step S1200 and step S1210, the jam occurrence processing illustrated in FIG. 8 is performed. After the jam occurrence processing is completed, the print controller 202 executes the standby process illustrated in FIG. 10. A flow in which a jam clearing operation is performed during the execution of the standby process will be described.

In step S2010, the print controller 202 determines whether any of the first opening/closing sensor 63, the second opening/closing sensor 64, and the third opening/closing sensor 65 has detected opening. Here, it is assumed that the user has opened the second door 61 and the second opening/closing sensor 64 has detected the opening of the second door 61. FIG. 11B illustrates the state of the recording apparatus 1 at this point. In this state, the user performs the jam clearing operation on the sheet 20 in the second housing 51, performs splicing, and closes the second door 61. FIG. 11C illustrates the state of the recording apparatus 1 at this point.

In step S2100, if it is determined that the opening/closing sensor that had detected the opening in step S2010 has detected closing, the process proceeds to step S2110.

In step S2110, the print controller 202 compares the pre-ejection conveyance amount Z with the door distance Ln corresponding to the door detected to be opening in step S2010. In this case, since the second opening/closing sensor 64 has detected the opening of the second door 61, the door distance Ln=L2. Therefore, it is determined whether Z<L2 holds. If Z<L2 holds, the process proceeds to step S2120. If Z<L2 does not hold, the process returns to step S2010. In this case, the jam has occurred after the pre-ejection conveyance amount Z had been set to 0 in step S1110 in FIG. 5. Therefore, Z=0, and Z<L2 holds. Thus, the process proceeds to step S2120.

In step S2120, the pre-ejection conveyance amount Z is updated to Ln. In this case, the pre-ejection conveyance amount Z is updated to L2. Thereafter, the process returns to step S2010.

When the process proceeds to step S2010, step S2020, and step S2030, and when it is determined that the recording start operation has been performed through the operation panel 103, the standby process ends, and the recording control operation in FIG. 5 is started.

The recording operation performed after the jam clearing operation performed on the jam that has occurred in the initial recording operation can be referred to as the second recording operation. This recording operation is started in the state illustrated in FIG. 11D in accordance with the recording control operation in FIG. 5.

In step S1100, when the sheet 20 has been conveyed by the pre-ejection conveyance amount Z=L2 set in step S2120, the process proceeds to step S1110. FIG. 11E illustrates the state of the recording apparatus 1 at this point. The spliced portion 80 is located on the downstream side of the sub conveyance unit 15 in the conveying direction. Therefore, a decrease in the conveyance accuracy and damage to the head 13 in the recording operation can be prevented. In addition, a waste sheet of L2 is generated. The waste sheet amount L2 is less than the waste sheet amount L1 generated when the jam occurs in the first housing 50.

Similarly, when the jam occurs in the third housing 52 in the initial recording operation, and the third door 62 is opened and closed to perform the jam clearing operation, the amount of waste sheet generated in the recording operation is L3, which is even less than the amounts of waste sheet L1 and L2 generated in the case where the first door 60 and the second door 61 are opened and closed.

### Case in Which Plurality of Doors Are Opened and Closed during Standby Process

It is assumed that, after the recording operation is stopped due to occurrence of a jam, first, the user opens the second door 61, only to find that the housing in which the jam has occurred is the third housing 52, and then closes the second door 61 and opens the third door 62 to perform the jam clearing operation. In this case, in step S2110 after the second door 61 has been opened and closed, it is determined whether Z<L2 holds. Since Z=0, in step S2120, Z=L2 is set. Subsequently, in step S2110 after the third door 62 has been opened and closed, it is determined whether Z<L3 holds. Since Z=L2, Z<L3 does not hold. Consequently, the process does not proceed to step S2120, and Z=L2 is maintained. In this case, the spliced portion 80 is actually generated by the jam clearing operation in the sheet 20 in the conveyance path 90 in the third housing 52. However, there is still a possibility that some abnormality occurs in the sheet 20 in the conveyance path 90 in the second housing 51 because the second housing 51 has temporarily been opened. In this case, in the embodiment, the ejection is started after the sheet 20 is conveyed by L2 in the recording operation after the standby process. Therefore, even if some abnormality has occurred in the sheet 20 in the second housing 51, a decrease in the conveyance accuracy and damage to the head 13 caused by the abnormality can be prevented.

On the contrary, it is assumed that, after the recording operation is stopped due to occurrence of a jam, first, the user opens the second door 61, only to find that the housing in which the jam has occurred is the first housing 50, and then closes the second door 61 and opens the first door 60 to perform the jam clearing operation. In this case, in step S2110 after the second door 61 has been opened and closed, it is determined whether Z<L2 holds. Since Z=0, in step S2120, Z=L2 is set.

Subsequently, in step S2110 after the first door 60 has been opened and closed, it is determined whether Z <L1 holds. Since Z=L2, Z<L1 holds. Thus, the process proceeds to step S2120, and Z is updated to Z=L1.

In this way, when a plurality of doors are opened and closed during the standby process, the door distance Ln corresponding to the door located at the most upstream in the conveying direction is set as the pre-ejection conveyance amount Z. In other words, in the recording operation after the opening and closing of two or more doors among the plurality of doors have been detected, the pre-ejection conveyance amount Z is set based on the longest door distance among the door distances corresponding to the two or more doors whose opening and closing have been detected. In this way, a decrease in the conveyance accuracy and damage to the head 13 due to the opening and closing of the door can be more reliably prevented.

### Case in Which User Conveyance Is Performed during Standby Process

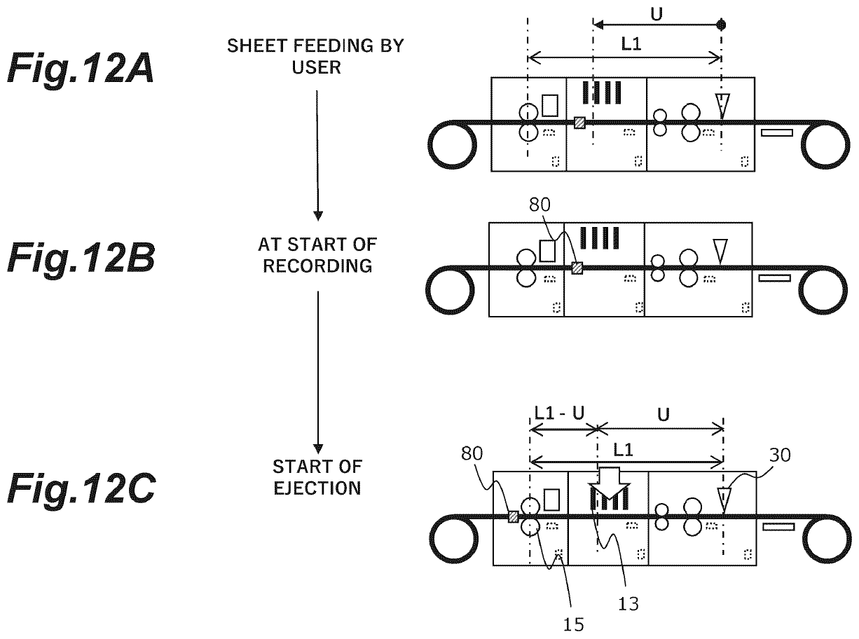

A flow in a case where it is determined that the user has performed the conveyance operation by using the operation panel 103 in step S2020 of the standby process will be described. Here, a case where the first door 60 has been opened and closed during the standby process will be described as an example. FIGS. 12A to 12C are diagrams illustrating a case where the conveyance is performed by the user operation when a jam has occurred in the embodiment.

In step S2200, the print controller 202 turns on the splice detection of the splice detector 30.

In step S2210, the print controller 202 causes the conveyance control unit 207 to drive the sheet feeding device 10, the main conveyance unit 12, the sub conveyance unit 15, and the winding device 17 to convey the sheet 20 while a conveyance operation (for example, pressing of a conveyance button) is performed by the user. When the conveyance operation by the user ends (for example, when the conveyance button is released), the conveyance control unit 207 stops the conveyance of the sheet 20.

In step S2220, the print controller 202 updates the pre-ejection conveyance amount Z by subtracting the distance of conveyance in step S2210 from the pre-ejection conveyance amount Z. FIG. 12A illustrates the state of the recording apparatus 1 at this point. For example, when a conveyance amount of the conveyance operation by the user is represented by a user conveyance amount U (second conveyance amount), since the pre-ejection conveyance amount Z set in step S2120 is L1, the pre-ejection conveyance amount Z is updated to Z=L1-U in step S2220. That is, when the user performs the conveyance operation after the opening and closing of the door has been detected, the amount obtained by subtracting the user conveyance amount U from the door distance Ln of the door whose opening and closing has been detected is set as the pre-ejection conveyance amount Z. Since not being used for recording, the user conveyance amount U of the sheet 20 will be waste sheet.

In step S2230, after the print controller 202 turns off the splice detection of the splice detector 30, the process returns to step S2010. In step S2030, if it is determined that the user has performed a recording start operation through the operation panel 103, the print controller 202 ends the standby process and starts the recording control operation in FIG. 5.

The recording operation performed after the jam clearing operation performed on the jam that has occurred in the initial recording operation can be referred to as the second recording operation. This recording operation is started in the state illustrated in FIG. 12B in accordance with the recording control operation illustrated in FIG. 5.

In step S1100, when the sheet 20 has been conveyed by the pre-ejection conveyance amount Z=L1-U set in step S2220, the process proceeds to step S1110. FIG. 12C illustrates the state of the recording apparatus 1 at this point. The spliced portion 80 is located on the downstream side of the sub conveyance unit 15 in the conveying direction. Thus, a decrease in the conveyance accuracy and damage to the head 13 in the recording operation can be prevented. Further, waste sheet of L1-U is generated. When this waste sheet of L1-U is combined with the waste sheet U generated in step S2210 of the standby process, waste sheet of L1-U+U=L1 is generated in the series of flows. This waste sheet amount is the same as that generated in the case where the user conveyance is not performed during the standby process. That is, the waste sheet of L1 is generated regardless of whether or not the user conveyance is performed.

The waste sheet amounts generated due to the pre-ejection conveyance in the initial recording operation, the second and subsequent recording operations, and the recording operation after the jam clearing operation according to the embodiment described above are summarized as follows.
(1) Waste sheet amount Ls in the initial recording operation
(2) Waste sheet amount 0 in the second and subsequent recording operations
(3) Waste sheet amount L1 in the recording operation after the jam clearing operation performed by opening and closing the first door 60 when a jam occurs during the recording operation
(4) Waste sheet amount L2 in the recording operation after the jam clearing operation performed by opening and closing the second door 61 when a jam occurs during the recording operation
(5) Waste sheet amount L3 in the recording operation after the jam clearing operation performed by opening and closing the third door 62 when a jam has occurred during the recording operation

In addition, in any of the recording operations, since the spliced portion 80 does not pass through the nip portions of the main conveyance unit 12 and the sub conveyance unit 15 and does not pass below the head 13 in the recording position, a decrease in the conveyance accuracy and damage to the head 13 can be prevented. Therefore, according to the embodiment, by changing the pre-ejection conveyance amount in accordance with recording conditions, a decrease in the conveyance accuracy and damage to the head 13 can be prevented while the amount of waste sheet caused by the pre-ejection conveyance is reduced.

Hereinafter, comparative examples for describing the advantageous effects of the embodiment will be described.

### Comparative Example 1

In Comparative Example 1, the pre-ejection conveyance amount Z is always set to a detection distance Ls, which is the distance between the sub conveyance unit 15 and the splice detector 30. Initial Recording Operation

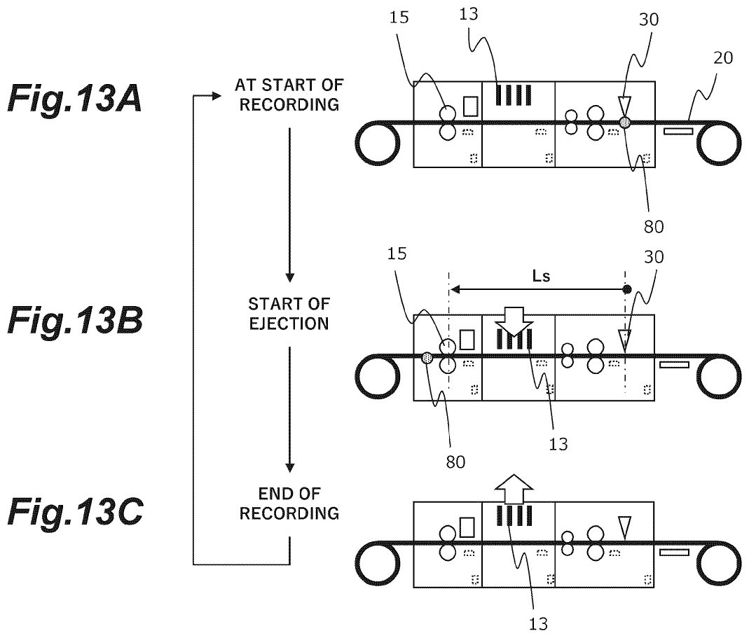

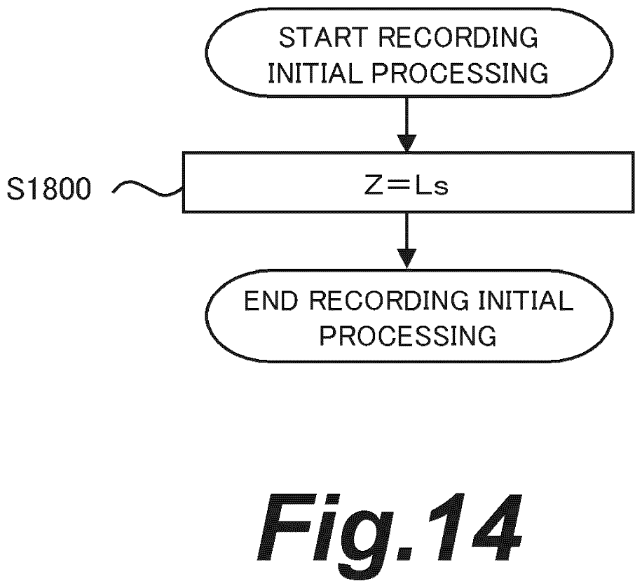

When an instruction for the initial recording operation after the activation of the recording apparatus 1 is entered, the recording control operation in FIG. 5 is started. In step S1000, the print controller 202 executes recording initial processing. In Comparative Example 1, the recording initial processing illustrated in FIG. 14 is executed. FIG. 14 is a flowchart illustrating the recording initial processing according to Comparative Example 1. In step S1800, the pre-ejection conveyance amount Z is set to Ls, and the recording initial processing ends. FIGS. 13A to 13C are diagrams illustrating operational states of the recording apparatus 1 according to Comparative Example 1. FIG. 13A illustrates the state of the recording apparatus 1 at this point. The head 13 is in a state elevated above the sheet 20.

After the recording initial processing is completed, the processing from step S1010 to step S1200 is performed. FIG. 13B illustrates the state of the recording apparatus 1 at this point. It has been checked by the splice detector 30 that the sheet 20 has no spliced portion 80 in the range from the splice detector 30 to the sub conveyance unit 15 in the conveyance path 90. Therefore, no spliced portion 80 passes through the sub conveyance unit 15 or below the head 13 in the recording operation so that a decrease in the conveyance accuracy and damage to the head 13 in the recording operation can be prevented. However, the sheet 20 with a length of Ls will be a waste sheet, which will not be used for recording.

Thereafter, the processing from step S1210 to step S1240 is performed, and the initial recording operation is completed. FIG. 13C illustrates the state of the recording apparatus 1 at this point.

### Second and Subsequent Recording Operations

When the initial recording operation is completed, the recording apparatus 1 enters a standby state. In the standby state, when an instruction for the second recording operation is entered, the recording control operation in FIG. 5 is started. In the second recording operation, too, the pre-ejection conveyance amount Z=Ls is set in step S1000. FIG. 13A illustrates the state at this point, which is the same as the state of the initial recording operation. The subsequent processing is the same as that in the initial recording operation, and the processing from step S1010 to step S1240 is performed. The second recording operation ends while the waste sheet corresponding to Ls is generated.

### Jam Occurrence Processing

A sequence in Comparative Example 1 will be described. In this sequence, a jam occurs between step S1200 and step S1210 in the initial recording operation, and the second recording operation is performed (the recording operation is resumed) after the jam clearing operation has been performed.

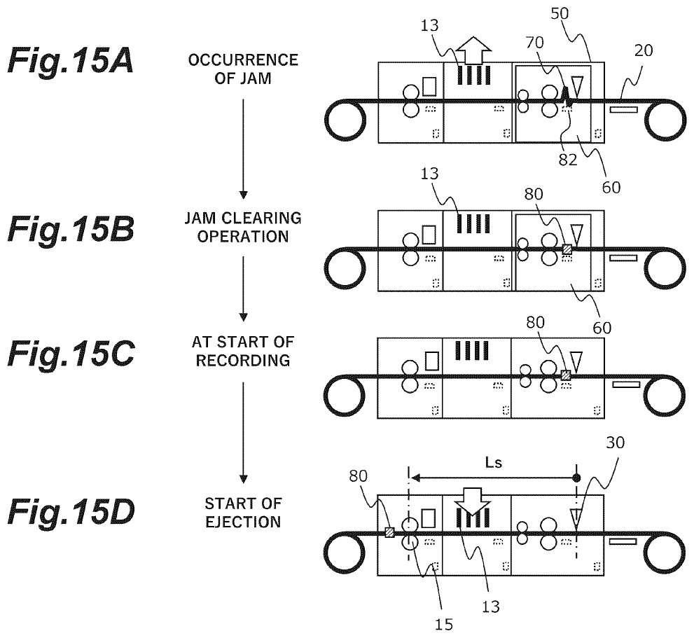

When a jam is detected by any one of the first jam detector 82, the second jam detector 83, and the third jam detector 84, the print controller 202 starts the jam occurrence processing illustrated in FIG. 8. Here, a case where a jammed portion 70 has occurred between the splice detector 30 of the first housing 50 and the main conveyance unit 12 will be described as an example with reference to FIGS. 15A to 15D. FIGS. 15A to 15D are diagrams illustrating operational states of the recording apparatus 1 according to Comparative Example 1 when the jam has occurred.

The jam occurrence processing is the same as that in the embodiment. That is, when the jam occurrence processing is started, the ejection by the head 13 is terminated, and the head 13 is raised. FIG. 15A illustrates the state of the recording apparatus 1 at this point. Next, the conveyance of the sheet 20 is stopped, and the splice detection of the splice detector 30 is turned off.

When the jam occurrence processing is completed, the recording apparatus 1 enters a standby state. The user performs the jam clearing operation while the recording apparatus 1 is in the standby state. In the example in FIGS. 15A to 15D, the user can perform the jam clearing operation by opening the first door 60 of the first housing 50, cutting out the jammed portion 70 to perform splicing, and closing the first door 60. FIG. 15B illustrates the state of the recording apparatus 1 at this point. When the jam clearing operation is completed, the user enters an instruction to resume the recording operation by operating the operation panel 103. FIG. 15C illustrates the state of the recording apparatus 1 at this point.

The recording operation performed after the jam clearing operation performed on the jam that has occurred in the initial recording operation can be referred to as the second recording operation. This recording operation is started in accordance with the recording control operation illustrated in FIG. 5. In step S1000, the pre-ejection conveyance amount Z is set to Ls. FIG. 15D illustrates the state where the processing from step S1010 to step S1200 has subsequently been performed. It has been checked by the splice detector 30 that the sheet 20 has no spliced portion 80 in the range from the splice detector 30 to the sub conveyance unit 15 in the conveyance path 90. The spliced portion 80 is located on the downstream side of the sub conveyance unit 15 in the conveying direction. The ejection starts from this state. Therefore, the spliced portion 80 does not pass through the sub conveyance unit 15 or below the head 13 in the recording operation so that a decrease in the conveyance accuracy and damage to the head in the recording operation can be prevented. Thereafter, the processing from step S1210 to step S1240 is performed, and the recording operation after the jam clearing operation ends.

In comparison with the embodiment, in the embodiment, the amount of waste sheet caused by the pre-ejection conveyance in the second and subsequent recording operations is 0, whereas in Comparative Example 1, a waste sheet of Ls is generated each time in the second and subsequent recording operations. In addition, in the embodiment, the pre-ejection conveyance amount in the recording operation after the jam clearing operation is set in accordance with the door opened and closed in the jam clearing operation, whereas, in Comparative Example 1, the pre-ejection conveyance amount in the recording operation after the jam clearing operation is Ls every time. Therefore, the embodiment is more advantageous than Comparative Example 1 in terms of reduction in the waste sheet amount. The embodiment and Comparative Example 1 are equivalent in terms of prevention of the decrease in the conveyance accuracy and the damage to the head 13 in the initial recording operation, the second and subsequent recording operations, and the recording operation after the jam clearing operation.

### Comparative Example 2

In Comparative Example 2, the pre-ejection conveyance amount Z in the initial recording operation is set to the detection distance Ls, and the pre-ejection conveyance amount Z in the second and subsequent recording operations is always set to zero.

### Initial Recording Operation

When an instruction for the initial recording operation after the activation of the recording apparatus 1 is entered, the recording control operation in FIG. 5 is started. In step S1000, the print controller 202 executes the recording initial processing. In Comparative Example 2, the recording initial processing illustrated in FIG. 6 is performed, which is the same as in the embodiment. FIG. 7A illustrates the state of the recording apparatus 1 at this point. This recording initial processing is the only difference between Comparative Example 2 and Comparative Example 1.

FIG. 7B illustrates the state where the processing from step S1010 to step S1200 has subsequently been performed. Thereafter, the processing from step S1210 to step S1240 is performed, and the recording operation ends. FIG. 7C illustrates the state of the recording apparatus 1 at this point.

### Second and Subsequent Recording Operations

When the initial recording operation is completed, the recording apparatus 1 enters a standby state. In the standby state, when an instruction for the second recording operation is entered, the recording control operation in FIG. 5 is started. The second recording operation is the same as that in the embodiment.

### Jam Occurrence Processing

A sequence in Comparative Example 2 will be described. In this sequence, a jam occurs between step S1200 and step S1210 in the initial recording operation, and the second recording operation is performed (the recording operation is resumed) after the jam has been cleared.

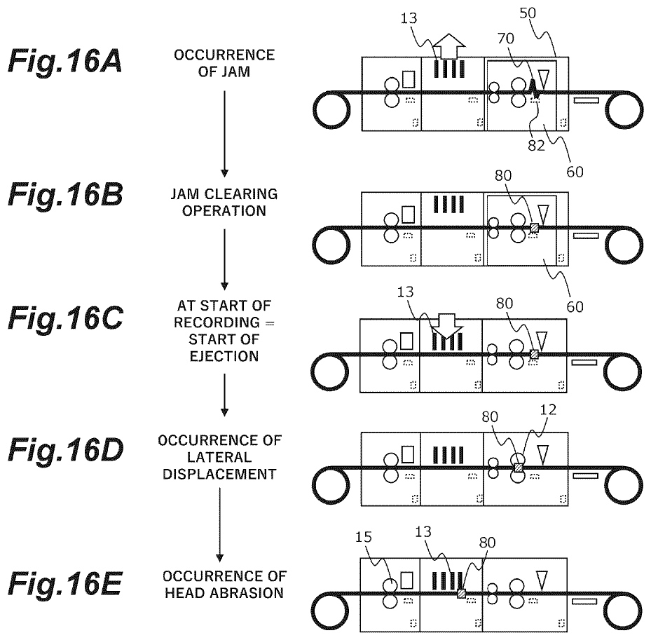

When a jam is detected by any one of the first jam detector 82, the second jam detector 83, and the third jam detector 84, the print controller 202 starts the jam occurrence processing illustrated in FIG. 8. Here, a case where a jammed portion 70 has occurred between the splice detector 30 of the first housing 50 and the main conveyance unit 12 will be described as an example with reference to FIGS. 16A to 16E. FIGS. 16A to 16E are diagrams illustrating the operation of the recording apparatus 1 according to Comparative Example 2 when the jam has occurred.

The jam occurrence processing is the same as that in the embodiment. That is, when the jam occurrence processing is started, the ejection by the head 13 is terminated, and the head 13 is raised. FIG. 16A illustrates the state of the recording apparatus 1 at this point. Next, the conveyance of the sheet 20 is stopped, and the splice detection of the splice detector 30 is turned off.

When the jam occurrence processing is completed, the recording apparatus 1 enters a standby state. The user performs the jam clearing operation while the recording apparatus 1 is in the standby state. In the example in FIGS. 16A to 16E, the user can perform the jam clearing operation by opening the first door 60 of the first housing 50, cutting out the jammed portion 70 to perform splicing, and closing the first door 60. FIG. 16B illustrates the state of the recording apparatus 1 at this point. When the jam clearing operation is completed, the user enters an instruction to resume the recording operation by operating the operation panel 103. FIG. 16C illustrates the state of the recording apparatus 1 at this point.

The recording operation performed after the jam clearing operation performed on the jam that has occurred in the initial recording operation can be referred to as the second recording operation. This recording operation is started in accordance with the recording control operation illustrated in FIG. 5. In the recording initial processing performed in step S1000, the pre-ejection conveyance amount Z is set to the value set in the immediately preceding processing. The pre-ejection conveyance amount Z set in the immediately preceding processing is 0, which is the value updated in step $1110 in the initial recording operation. Subsequently, the processing of step S1010 and step S1020 is performed, and the conveyance is started. In the next step S1100, since the pre-ejection conveyance amount Z=0, the process immediately proceeds to step S1200 via step S1110, and ejection is started. FIG. 16C illustrates the state at this point.

In step S1200, the head carriage control unit 208 lowers the head 13, and the print controller 202 causes the head 13 to start ejection via the head I/F 206. Thereafter, when the conveyance proceeds, the spliced portion 80 reaches the nip portion of the main conveyance unit 12. FIG. 16D illustrates this state. This is the state where the conveyance accuracy could deteriorate when the convex portion of the spliced portion 80 passes through the nip portion. When the conveyance further proceeds, the spliced portion 80 reaches the position below the lowered head 13. FIG. 16E illustrates this state. This is the state where the head 13 could be damaged when the convex portion of the spliced portion 80 passes under the lowered head 13. When the conveyance further proceeds, the spliced portion 80 reaches the nip portion of the sub conveyance unit 15. In this state, the conveyance accuracy could deteriorate, as in the case of the main conveyance unit 12. Thereafter, the processing from step S1210 to step S1240 is performed, and the recording operation ends.

In comparison with the embodiment, the amount of waste sheet caused by the pre-ejection conveyance in the second and subsequent recording operations is 0, and thus, the embodiment and Comparative Example 2 are equivalent in that the waste sheet amount can be reduced in the initial recording operation and the second and subsequent recording operations. However, In the embodiment, the pre-ejection conveyance amount in the recording operation after the jam clearing operation is set in accordance with the door opened and closed in the jam clearing operation, whereas, in Comparative Example 2, the pre-ejection conveyance amount in the recording operation after the jam clearing operation is 0 every time. Therefore, as described above, in the recording operation after the jam clearing operation, the embodiment can achieve both the reduction of the waste sheet amount and the prevention of the decrease in the conveyance accuracy and the damage to the head 13, whereas, in the comparative example 2, although the waste sheet amount can be reduced, the conveyance accuracy could decrease and the head 13 could be damaged. In this respect, the embodiment is more advantageous than Comparative Example 2.

### Modifications of Embodiment

In the example described above, the door distance L1 in the case where the first door 60 is opened and closed is the same as the distance (the detection distance Ls) between the sub conveyance unit 15 and the splice detector 30. However, the door distance L1 and the detection distance Ls may be different values. For example, the door distance L1 may be the distance between the sub conveyance unit 15 and the most upstream position of the sheet 20 on the conveyance path 90, the sheet 20 being accessible by the user when the first door 60 is opened. When the most upstream position accessible by the user is on the downstream side of the splice detector 30, L1<Ls holds. Therefore, in comparison with the embodiment, it is possible to further reduce the waste sheet amount in the recording operation after the jam clearing operation is performed by opening and closing the first door 60. In this case, the default pre-ejection conveyance amount Z set in the initial recording operation after the activation of the recording apparatus 1 is set to the detection distance Ls.

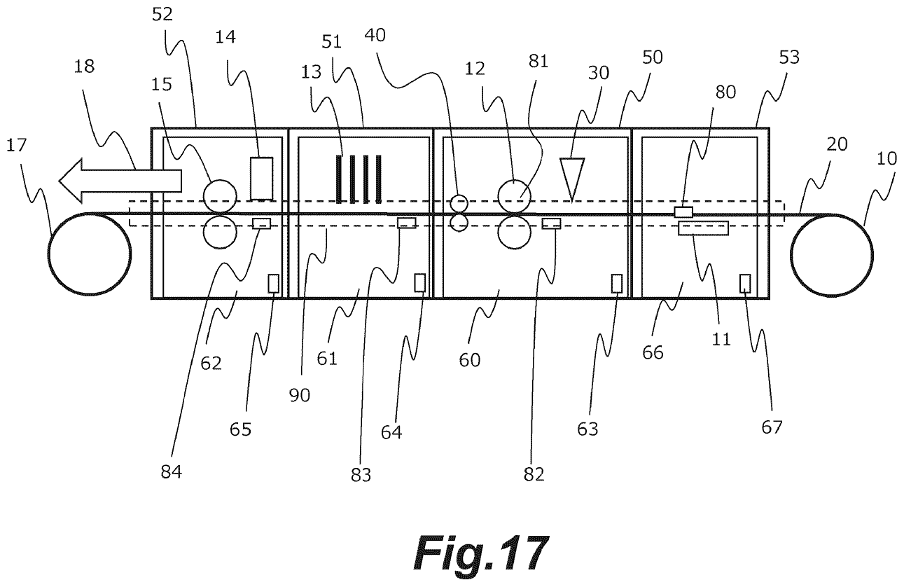

In the configuration example in the embodiment described above, the first housing 50 including the splice detector 30 inside is located at the most upstream in the conveying direction. However, the configuration of the recording apparatus 1 is not limited to such a configuration. For example, as illustrated in FIG. 17, a fourth housing 53 including a fourth door 66 and a fourth opening/closing sensor 67 may be provided on the upstream side of the first housing 50 including the splice detector 30 inside in the conveying direction. When the fourth door 66 is opened, the user can operate the sheet 20 in the fourth housing 53, the sheet 20 being located on the upstream side of the detection position of the splice detector 30 in the conveying direction. In the case of the housing configuration described above, the pre-ejection conveyance amount Z can be set based on the door distance Ln, only in the recording operation after detection of opening and closing of the door of the housing including the sheet 20 operable by the user when the door of the housing is opened, the sheet 20 being located on the downstream side of the detection position 30X. Therefore, in the recording operation after the opening and closing of the fourth door 66 is detected, the processing for setting the pre-ejection conveyance amount Z based on a door distance L4 corresponding to the fourth door 66 as in the embodiment is not performed. That is, in the standby process in FIG. 10, the fourth door 66 is not subject to the processing from step S2010 to step S2120. In this case, in the recording operation after the opening and closing of the fourth door 66 is detected, the pre-ejection conveyance amount Z may be set to 0. That is, in the recording operation after the opening and closing of the fourth door 66 is detected, the ejection of step S1200 is started without performing the conveyance processing of step S1100. Even if the fourth door 66 is opened and closed and a spliced portion or abnormality occurs in the sheet 20 in the fourth housing 53, the spliced portion or abnormality will be detected by the splice detector 30. Therefore, there will be no case where a spliced portion or abnormality reaches the main conveyance unit 12 or the sub conveyance unit 15 and causes a decrease in the conveyance accuracy or interference to damage the head 13.

In the configuration example in the embodiment described above, the recording apparatus 1 includes a plurality of housings (the first housing 50, the second housing 51, and the third housing 52), and doors (the first door 60, the second door 61, and the third door 62) are provided in the respective housings. However, the configuration of the recording apparatus is not limited to this example. For example, the recording apparatus 1 may include one housing that contains the conveyance path 90 of the sheet 20 inside, and a plurality of doors may be provided in the housing along the conveyance path 90 such that different positions of the sheet 20 on the conveyance path 90 can be accessed by different doors that open and close. In this case, the distance between the sub conveyance unit 15 and a most upstream position in the conveyance path 90, the position being accessible by the user when each door is opened, can be set as a door distance corresponding to each door.

According to the present disclosure, it is possible to reduce the waste sheet amount in a recording apparatus that conveys a sheet when a splice between sheets is detected.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-070427, filed on Apr. 24, 2024, which is hereby incorporated by reference herein in its entirety.

What is claimed is:

1. A recording apparatus that records an image by ejecting liquid onto a sheet supplied from a roll around which the sheet is wound, the recording apparatus comprising:
a first conveyance unit configured to convey a sheet in a conveying direction;
a second conveyance unit configured to convey a sheet and provided on a downstream side of the first conveyance unit in the conveying direction;
a head configured to eject liquid onto a sheet at a position between the first conveyance unit and the second conveyance unit in a conveyance path of the sheet;
a sensor configured to detect a spliced portion, which is a splice between sheets, at a detection position on an upstream side of the head in the conveying direction; and
a control unit configured to convey a sheet by a first conveyance amount while inspecting the sheet by the sensor before causing the head to start ejecting liquid, and cause the head to start ejecting the liquid onto the sheet in a case where the spliced portion is not detected by the sensor while the sheet is conveyed by the first conveyance amount,
wherein the control unit changes the first conveyance amount.

2. The recording apparatus according to claim 1, wherein the control unit sets the first conveyance amount based on a detection distance, which is a distance between the detection position and a position of the second conveyance unit along the conveyance path, in an initial recording operation after activation of the recording apparatus.

3. The recording apparatus according to claim 2, wherein the control unit sets the first conveyance amount to zero in a second and subsequent recording operations after the initial recording operation.

4. The recording apparatus according to claim 1, wherein the first conveyance unit and the second conveyance unit each conveys a sheet by pinching the sheet by a roller pair.

5. The recording apparatus according to claim 1, further comprising a sheet feeding unit configured to supply a sheet from a roll, on an upstream side of the first conveyance unit in the conveying direction.

6. The recording apparatus according to claim 1, further comprising a winding unit configured to wind up a sheet, on a downstream side of the second conveyance unit in the conveying direction.

7. The recording apparatus according to claim 1, further comprising a housing configured to contain at least a part of the conveyance path inside, the housing having an opening, a door configured to open and close the opening, and an opening/closing sensor configured to detect opening and closing of the door, and the housing being configured to allow an operation to be performed on a sheet on the conveyance path in the housing via the opening,
wherein the control unit sets the first conveyance amount based on a door distance in a recording operation after the opening/closing sensor has detected opening and closing of the door, the door distance being a distance along the conveyance path between a position of the second conveyance unit and a most upstream position of a sheet that is operable by a user while the door is opened in the housing in the conveying direction.

8. The recording apparatus according to claim 7,
wherein the housing includes a plurality of the openings and the doors along the conveyance path, and is configured to allow an operation to be performed on a sheet at different positions of the conveyance path in the housing via each of the plurality of openings,
wherein the opening/closing sensor is configured to detect opening and closing of each of the plurality of doors, and
wherein, in a recording operation after the opening/closing sensor has detected opening and closing of any of the plurality of doors, the control unit sets the first conveyance amount based on the door distance corresponding to the door of which opening and closing have been detected.

9. The recording apparatus according to claim 8, wherein, in a recording operation after the opening/closing sensor has detected opening and closing of two or more doors among the plurality of doors, the control unit sets the first conveyance amount based on a longest door distance among the door distances corresponding to the two or more doors of which opening and closing have been detected.

10. The recording apparatus according to claim 8, wherein the control unit sets the first conveyance amount based on the door distance only in a recording operation after the opening/closing sensor has detected opening and closing of a downstream door among the plurality of doors, where the downstream door is defined such that a position of a sheet that is operable by a user while the downstream door is opened in the housing is on a downstream side of the detection position in the conveying direction.

11. The recording apparatus according to claim 7, further comprising an abnormality detection unit configured to detect abnormality of a sheet in the conveyance path,
wherein the control unit sets the first conveyance amount based on the door distance, only in a case where the opening/closing sensor detects opening and closing of the door after the abnormality detection unit has detected abnormality of a sheet.

12. The recording apparatus according to claim 7, further comprising an input unit configured to allow a user to input a conveyance instruction to convey a sheet by a given conveyance amount,
wherein, in a case where a sheet is conveyed by a second conveyance amount in accordance with the conveyance instruction after the opening/closing sensor has detected opening and closing of the door, the control unit, in a subsequent recording operation, sets the first conveyance amount based on an amount obtained by subtracting the second conveyance amount from the door distance.

13. A control method for controlling a recording apparatus that records an image by ejecting liquid onto a sheet supplied from a roll around which the sheet is wound, the recording apparatus including:
a first conveyance unit configured to convey a sheet in a conveying direction;
a second conveyance unit configured to convey a sheet and provided on a downstream side of the first conveyance unit in the conveying direction;
a head configured to eject liquid onto a sheet at a position between the first conveyance unit and the second conveyance unit in a conveyance path of the sheet; and
a sensor configured to detect a spliced portion, which is a splice between sheets, at a detection position on an upstream side of the head in the conveying direction, the control method comprising the steps of:
conveying a sheet by a first conveyance amount while inspecting the sheet by the sensor before causing the head to start ejecting liquid; and
causing the head to start ejecting liquid onto the sheet in a case where the spliced portion is not detected by the sensor in step of conveying,
wherein the first conveyance amount in the step of conveying is changed.
